(19) United States
(12) Patent Application Publication
(10) Pub. No.: US 2008/0029495 A1
(43) Pub. Date: Feb. 7, 2008

(54) Method and Device for Laser Welding of Components Made from Super Alloys

(75) Inventors: Klaus Emiljanow, Sehnde (DE); Stefan Czerner, Hannover (DE); Axel Bormann, Bamberg (DE); Karl Lindemann, Burgwedel (DE); Peter Stippler, Marienhagen (DE); Joerg Werhahn, Schwerte (DE)

Correspondence Address: DAVIDSON, DAVIDSON & KAPPEL, LLC, 485 SEVENTH AVENUE, 14TH FLOOR, NEW YORK, NY, 10018, US

(73) Assignee: MTU Aero Engines GmbH, Muenchen (DE)

(21) Appl. No.: 11/578,448

(22) PCT Filed: Apr. 13, 2005
(86) PCT No.: PCT/DE05/00663

§ 371 Date: Jun. 21, 2007

(30) Foreign Application Priority Data
Apr. 17, 2004 (DE) 10 2004 018 699.5

(51) Int. Cl. B23K 26/20

(52) U.S. Cl. 219/121.61

(57) ABSTRACT

A method for laser welding super alloys is disclosed. The power of the laser (12) is controlled depending on the temperature of the welding bath and a device (10) for laser welding a super alloy, including a laser beam source (12), a process controller (30), a temperature recording unit (28) and a feed device (24) for additional materials, characterized in that the process controller (30) comprises a regulator (34), connected to the temperature recording unit (28) and the laser source (12).

The present invention relates to a method for laser welding of components made of super alloys and to a device for carrying out the method.

The weldability of super alloys is frequently problematic and limited. In the field of turbines, such as stationary gas turbines or turbines in aircraft engines, the use of refractory materials is essential because of the requirements placed on these components. Gamma-phase hardenable super alloys, which are referred to as MCrAlY alloys, are mostly used as materials for manufacturing such components. However, these super alloys are problematic with regard to their weldability, which is a particular disadvantage since turbine vanes must be frequently welded, during manufacturing as well as during servicing. For example, weld layers must be applied to the edges of the vane tips of turbine vanes and compressor vanes in regular intervals due to the wear during operation.

So far it has been customary to heat components made of super alloys, which are problematic to weld, to high temperatures, e.g., 1000° C., before they are welded. This heating should prevent solidification cracks and segregation cracks as well as cracks due to separation of intermetallic Ni₃Al and Ni₃Ti phases. U.S. Pat. No. 5,554,837 describes such a laser powder deposit welding in which the workpiece is subjected to inductive preheating prior to welding. In the method according to the related art, this inductive heating may also be sustained during and after the welding process. Intended temperature characteristics and thus an intended separation behavior are achieved in this way. In particular, these materials became ductile to some extent at the increased temperatures.

A disadvantage of such a method is the complicated heating of the component to 1050° C. The heat-affected zone of the welding area or the weld is greater compared to cold welding; the contour of the component cannot be accurately built up and the danger of weld sagging is unavoidable when thin walls are involved. Moreover, the additional preheating makes the process expensive and lowers the productivity. In addition, the weld pool is negatively affected by the induction coil.

Therefore, it is the object of the present invention to provide a method and a device which make it possible to weld components made of super alloys without the risk of crack formation. At the same time, the method should be easy to execute and should allow for high productivity.

The present invention is based on the recognition that this object may be achieved by monitoring and controlling the laser welding work process.

Therefore, according to a first embodiment, the object is achieved by a method for laser welding of super alloys in which the power of the laser is controlled as a function of the temperature of the weld pool.

By controlling the power based on the temperature of the weld pool, workpieces made of super alloys, in particular nickel and cobalt super alloys, such as turbine vanes, may be economically machined free of cracks with high quality. Moreover, very thin walls may be welded without weld sagging due to the process-controlled laser power. Using temperature-controlled laser beam deposit welding according to the present invention, single-crystal or directionally solidified nickel super alloys as well as cobalt super alloys may be welded. By controlling the power based on the measured weld pool temperature and by controlling the temperature variation, the temperature of the weld pool may be set in such a way that segregations, which result in crack formation, do not occur at all or only to a minor extent. In addition to the temperature, how long the alloy remains in a certain temperature range may be relevant for forming a certain phase. By rapidly passing through a temperature range in which certain segregations are formed, the amount of segregations, their form, or their size may be influenced, for example. These factors may be taken into account in setting the laser power. The laser power is calculated on the basis of the temperature measurement using mathematical functions.

The method is preferably executed on a cold workpiece. According to the present invention, a cold workpiece or component refers to a workpiece which is not preheated and thus has essentially the ambient temperature. When a cold workpiece is used, which is made possible by temperature control according to the present invention, the components do not have to be preheated to 1050° as is necessary in methods of the related art. Among other things, one advantage here is that, since preheating is omitted, less heat is introduced and the contour of the component may be accurately rebuilt. The cost of a possible downstream grinding step may be substantially reduced.

According to a preferred specific embodiment, the temperature of the weld pool is pyrometrically detected. A weld pool is formed from the material due to the power introduced via the laser beam. Electromagnetic radiation is emitted from the laser beam-material interaction zone. This radiation may be detected by a pyrometer and may be used for determining the temperature. This contactless determination of the weld pool temperature makes it possible to place the measuring device in a suitable position relative to the workpiece and the weld pool. This makes it possible to reliably determine the temperature which is used as an input variable for the temperature-based power control according to the present invention.

The temperature may be measured using laser focusing optics. For example, the temperature may be measured using a semitransparent mirror and a lens provided for deflecting the laser beam. This ensures that the temperature is always detected in the area of the effective zone between the material and the laser beam. But it is also possible to detect the temperature laterally from the laser focusing optics. In this case, the measuring device is appropriately aligned in order to always detect the weld pool temperature.

The method according to the present invention may be preferably executed in automated form, in particular via a CNC machine (computer numerically controlled). Due to the automation of the method, the rate of feed, i.e., the relative movement between the workpiece and the laser beam in particular, may be precisely and reproducibly set based on predefinable data. In addition to the temperature control strategy, the component target contour and the component actual contour, the data for the shape of the welding line, and all parameter-relevant data may be used for the automation. For example, the dwelling time of the laser beam at one point may be precisely set by suitably setting the rate of feed of the workpiece. Due to the additional temperature measurement and control of the laser power according to the present invention, exact compliance with temperature-time regimes may be ensured and deposit welding of super alloys free of cracks may be implemented.

Gamma-phase hardenable super alloys in particular are suitable as super alloys which may be treated using the method according to the present invention. These alloys, in which hardening is achieved via segregation of the gamma phase, may be monocrystalline or also alloys having directionally solidified segregations.

The power of the laser is preferably set in such a way, i.e., controlled based on the weld pool temperature during welding, that a temperature variation in the formation of gamma phases results via which the gamma phases are segregated in a crack-uncritical range.

The method according to the present invention is preferably a laser deposit welding method which is used, for example, for machining turbine vane tips. However, the method according to the present invention may also be used for other welding processes on components for gas turbines or for aircraft engines which are made of super alloys. The filling material may be added in form of a powder or in the form of a wire concentrically to the laser beam or laterally thereto.

According to a specific embodiment, the method according to the present invention includes the following steps: positioning the workpiece, detecting the workpiece contour, generating an NC code, moving the component into an inert gas chamber, temperature-controlled laser deposit welding, and removing the workpiece. The repeatability of the method result may be ensured by automating all or some of these steps.

According to another aspect, the present invention relates to a device for laser welding of a super alloy, including a laser beam source, a process control unit, a temperature detector, and an adding device for filler materials. The device is characterized in that the process control unit has a controller which is connected to the temperature detector and the laser source. In particular, the controller is connected to the control unit of the laser source via which the laser power is set. The power to be set is obtained in the controller based on the temperature values which have been ascertained by the temperature detector. An additional unit for processing and conveying the data detected by the temperature detector may be provided in the connection between the temperature detector and the controller. This processing and conveying unit may also be integrated into the temperature detector.

The temperature detector is preferably designed in such a way that the weld pool temperature is detected.

In one specific embodiment, the adding device allows for feed of the filler material that is concentric with the laser beam. However, it is also possible to feed the filler material laterally to the laser beam. The filler material may be fed in the form of a powder or as a wire.

The device preferably includes a work fixture for receiving and securing the workpiece, the work fixture being connected to the control unit and controlled via the control unit. This makes it possible to achieve a targeted relative movement of the workpiece toward the laser beam and thus to maintain a temperature-time regime. But it is also possible to control the work fixture by a separate control unit. In this case, the temperature control strategy, which is used by the controller, is preferably taken into account in the separate control unit in order to be able to maintain a predefined temperature-time regime.

The advantages and features which are described with regard to the method according to the present invention are—as far as applicable—similarly effective for the device according to the present invention and vice-versa.

The present invention is described in greater detail in the following with reference to the appended figures.

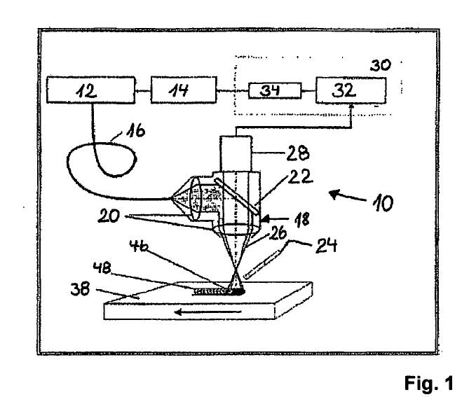

FIG. 1 shows a schematic block diagram of the system technology of a specific embodiment of the device according to the present invention, and

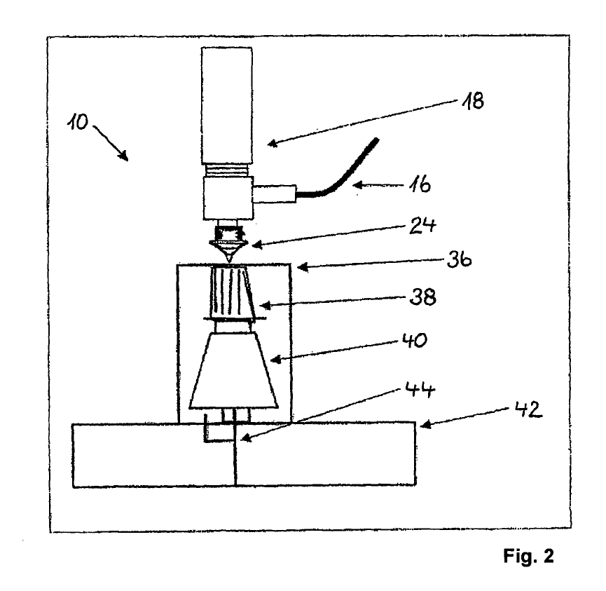

FIG. 2 shows another schematic view of a specific embodiment of the device according to the present invention.

In the illustrated specific embodiment, device 10 according to the present invention includes a laser beam source 12 having a control unit 14 connected thereto and a beam guide or an optical wave guide 16 which guides the laser beam to a laser head 18. Processing optics 20 as well as a semitransparent mirror 22 are provided in laser head 18. Moreover, device 10 includes a feed 24 for the filler material. In the specific embodiment in FIG. 1, this feed is situated laterally to laser beam 26 and in FIG. 2 concentrically to laser beam 26 in the specific embodiment.

A pyrometer 28 which, as is apparent from FIG. 1, is situated above laser head 18, is provided in device 10 according to the present invention for detecting the temperature.

A process control unit 30, which has a processing and conveying unit 32 for measured data of pyrometer 28 and a controller 34, is connected to pyrometer 28 and control unit 14 of laser beam source 12 in device 10.

In inert gas chamber 36, only shown in FIG. 2, a workpiece or component 38 may be held in a work fixture 40 which is illustrated as a quick-action clamping device.

A possible specific embodiment of the method according to the present invention is described below.

Component 38 that as indicated in FIG. 2 may represent a turbine vane, for example, is positioned with great repeat accuracy using quick-action clamping device 40. Quick-action clamping device 40 preferably has an aerodynamically favorable design in order to not interfere with gas flows in inert gas chamber 36.

After clamping, the component contour is detected using a laser scanner (not shown) which is positioned above component 38 via CNC axes 42. The actual contour of component 38 is ascertained from the measured data using software (not shown). With the aid of the target contour of component 38, an individual NC code is calculated which contains the temperature control strategy and all parameter-relevant data in addition to the path data. Inert gas chamber 36 is positioned above workpiece 38 via CNC axes 42, filled with inert gas via an almost laminar gas flow 44, and laser head 24 is positioned above component 38.

The weld pool temperature is measured using the system technology illustrated in FIG. 1. A weld pool is formed in process zone 46 due to laser beam 26. The electromagnetic radiation emitted from beam-material interaction zone 46 is measured through processing optics 20 and semitransparent mirror 22 using pyrometer 28. The measured data are collected in detector 32 in process control unit 30 and the required laser power is conveyed to laser control device 14 via controller 34. Laser beam source 12, which may be an Nd·YAG (neodymium-doped yttrium-aluminum-garnet) laser beam source, acts upon workpiece 38 using this power via beam guide (optical wave guide) 16 and processing optics 20. A weld 48 is generated by displacing workpiece 38 in the direction indicated in FIG. 1 by the arrow or by appropriately moving laser head 18.

The filler material is applied via powder feed or wire feed 24 optionally concentrically with laser head 18 or laterally to laser beam 26.

The laser welding process is automatically executed via the CNC controller and the component is moved into a loading and unloading position for removal from the system.

The time-temperature regime, which is to be set for the method according to the present invention, depends on the material as well as the workpiece geometry. Control of the laser power according to the present invention is the key to crack-free welding lines and takes place based on the temperature via transition functions in the control system. In addition, the workpiece geometry may be optimally taken into account in the automated process.

The present invention thus makes it possible to achieve the following advantages: crack-free deposit welding of crack-sensitive super alloys may be carried out without preheating. Shape distortion is reduced due to controlled laser power. The welding quality is improved due to process control and welding of thin walls without weld sagging is possible. Reproducibility may be achieved by setting parameters for the welding process and, finally, economical machining of the components is made possible by contour-accurate welding.

1-13. (canceled)

14. A method for laser welding of super alloys comprising:
controlling a laser power as a function of a weld pool temperature to laser weld,
a gamma-phase hardenable super alloy the laser power being controlled so that a temperature variation in a formation of gamma phases results through which the gamma phases are segregated in a crack-uncritical range.

15. The method as recited in claim 14, wherein the method is carried out on a cold work piece.

16. The method as recited in claim 14 further comprising detecting the weld pool temperature pyrometrically.

17. The method as recited in claim 14, further comprising detecting the temperature through a laser focusing optics.

18. The method as recited in claim 14 wherein the method is carried out in an automated manner, in particular by using a CNC system.

19. The method as recited in claim 18, wherein the method is carried out via a CNC system.

20. The method as recited in claim 14, wherein the method is a laser deposit welding method.

21. The method as recited in claim 14 further comprising:
positioning a work piece, detecting the work piece contour, generating a CN code, moving the work piece into an inert gas chamber, and removing the work piece.

22. A device for laser welding of a super alloy comprising:
a laser source, a process control unit;
a temperature detector;
an adding device for filler materials, the process control unit including a controller connected to the temperature detector and the laser source;
and an inert gas chamber including a quick-action clamp, the quick-action clamp having an aerodynamic design reducing interference with gas flows in the inert gas chamber.

23. The device as recited in claim 22, wherein the temperature detector is a weld pool temperature detector.

24. The device as recited in claim 22, wherein the adding device allows a feed that is concentric with the laser beam.

25. The device as recited in claim 22, wherein the clamp is connected to the control unit and controlled by the control unit.
